(19) United States
(12) Patent Application Publication
(10) Pub. No.: US 2025/0326248 A1
(43) Pub. Date: Oct. 23, 2025

(54) ITEM WITH A BACKLIT PLIQUE-À-JOUR ENAMEL DECORATION AND METHOD FOR MANUFACTURING SAME

(71) Applicant: Comadur SA, Le Locle (CH)

(72) Inventor: Johan ROMAND, Mamirolle (FR)

(73) Assignee: Comadur SA, Le Locle (CH)

(21) Appl. No.: 19/073,267

(22) Filed: Mar. 7, 2025

(30) Foreign Application Priority Data
Apr. 23, 2024 (EP) 24171992.1

(51) Int. Cl. B44C 3/00; G04B 19/28

(52) U.S. Cl. CPC B44C 3/005; G04B 19/283

(57) ABSTRACT

A method for manufacturing an item (1) comprising a through-decoration (2) forming a so-called backlit plique-à-jour enamel, the method including obtaining a blank (5); removing part of the blank (5) from the inner face (5b) of the blank (5) to produce a decoration (2a) that does not pass through to the outer face (5a); depositing, from the inner face (5b), one or more layers of enamel (3) within the non-through decoration (2a); depositing, from the inner face (5b), a layer of luminescent material (4) on the enamel (3); depositing a protective layer (6) on the layer of luminescent material (4); and machining the outer face (5a) to reveal the enamel. Also, the related item.

### CROSS REFERENCE TO RELATED APPLICATION

This application claims priority to European Patent Application No. 24171992.1 filed Apr. 23, 2024, the entire contents of which are incorporated herein by reference.

### TECHNICAL FIELD OF THE INVENTION

The invention relates to a method for manufacturing an item with a backlit plique-à-jour enamel decoration. The method according to the invention makes it possible to produce large series at a reduced cost. The invention further relates to the item produced by this method.

### TECHNOLOGICAL BACKGROUND

Plique-à-jour is a technique for applying enamel to a substrate that has no bottom at the level of the enamel. The lack of any bottom allows light to filter through the transparent or translucent enamel. The result is a miniature stained glass effect.

The conventional plique-à-jour technique consists of creating welded partitions with a metal that remains stable when the enamel is fired. During the successive firings of the layers deposited one by one, the metal partitions, mainly made of yellow or white gold for their properties, can deform or even separate from the substrate, which greatly limits the number of kiln passages and the designs that can be produced.

Moreover, a substrate is required during deposition and firing to ensure that the enamel does not run beyond the partition. As the substrates are made of quartz, it is very difficult to carry out this operation on non-planar shapes. Conventional enamel is deposited by hand, with a brush or an oiler. The layers deposited using these means are very thin, requiring dozens of layers to be deposited to achieve a total thickness that is typically less than 0.5 mm. Because of its thinness, the enamel obtained is quite fragile.

As this technique is tedious and not very reproducible, timepieces with a plique-à-jour dial are unique pieces or are produced in ultra-limited series at an exorbitant cost. To date, this lack of repeatability prevents watch manufacturers from mass-producing timepieces.

In addition to this productivity aspect, a luminescent effect can be sought after for the decorations, in particular for the indices of a bezel or dial.

### SUMMARY OF THE INVENTION

The aim of the present invention is to overcome the above-mentioned drawbacks by proposing a manufacturing method that makes it possible to produce pieces with a plique-à-jour enamel decoration in large series at a low cost and with increased enamel strength. The present invention also aims to give a luminescent effect to this plique-à-jour enamel decoration.

To this end, the invention relates to a method for manufacturing an item comprising a through-decoration filled with at least one enamel and a luminescent material to form a so-called backlit plique-à-jour enamel, the method comprising the steps of:
Obtaining a blank defined with an outer face, which is the face intended to face an observer, and with an inner face, which is an opposite face to the outer face;
Removing part of the blank from the inner face to produce a decoration that does not pass through to the outer face or, alternatively, in the previous step, obtaining said blank directly with the non-through decoration;
Depositing, from the inner face, one or more layers of enamel within the non-through decoration and firing the enamel after each layer has been deposited;
Depositing, from the inner face, a layer of luminescent material on the enamel;
Depositing, from the inner face, a protective layer on the layer of luminescent material;
Machining, preferably by grinding, the outer face to reveal the enamel and thus produce the item with the through-decoration.

Preferably, the through-decoration is then polished.

This method is highly reproducible, allowing large production volumes to be achieved at very low cost.

This method allows thick layers of enamel to be deposited, making it possible to obtain an enamel with a total thickness greater than or equal to 0.5 mm with a limited number of layers, typically less than 10. This greater thickness of the enamel compared with that of enamels in the prior art means that it is less brittle and can thus be used to make external components, such as bezels, which are subject to significant stress.

More typically, the use of enamel rather than lacquer provides excellent chemical and mechanical resistance, unlike standard lacquered bezels. Enamel is also one of the materials considered to be noble in watchmaking and jewellery, unlike lacquer.

Polymerisation of the luminescent material and of the protective layer during the deposition steps takes place at very low temperatures, typically around 80° C., which do not damage the enamel. The protective layer, which is typically lacquer, protects the luminescent material from the external environment but also reflects the luminescence towards the enamelled side. The enamel on the outside protects the luminescent decoration from mechanical wear.

The invention is also based on the ability to grind the substrate and the enamel at the same time, while guaranteeing an optimum surface finish on both materials. Polishing the enamel also means that the part does not have to be reheated in the kiln to give it its final shiny, translucent appearance.

The transparent enamel decoration will create a depth that is impossible to achieve today. Moreover, because the luminescent material is set far back, the luminescent effect will be perceptible even in brightly lit environments. The colours of the luminescent material and the colours of the translucent enamel can also be combined in order to obtain new panels of luminescent colours. Colour gradations can also be deposited in the enamel, for example, by spraying.

### BRIEF DESCRIPTION OF THE FIGURES

FIGS. 1a to 1f show the 6 steps of the method according to the invention. In each figure, a diagrammatic cross-sectional view of part of the item or blank and a three-dimensional view of part of the item or blank are shown. The three-dimensional views in FIGS. 1a and 1f are views from above the blank or item respectively, i.e. from the outer face, whereas views 1b to 1e are views from below the blank, i.e. from the inner face.

FIGS. 2a to 2c diagrammatically show cross-sectional views of the item for the additional and optional steps in the method according to the invention.

FIG. 3 is a three-dimensional view of the item produced by the method.

### DETAILED DESCRIPTION OF THE INVENTION

The invention relates to a method for manufacturing an item with a backlit plique-à-jour enamel decoration. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial and a hand. It may also consist of a component of the movement such as an oscillating weight. The method is particularly well suited to the manufacture of items subject to high stresses, such as an external component. Hereafter, the invention will be more specifically described for a bezel.

The manufacturing method is suitable for any substrate with a melting point higher than that of the enamel firing temperature, which is typically between 650° C. and 1100° C. depending on the composition of the enamel. The method is particularly well suited to a substrate made of a hard material such as ceramic, for example silicon nitride, zirconium oxide or aluminium oxide, or such as a sapphire or like a cermet. Some ceramics, particularly ZrO₂, have excellent mechanical-chemical adhesion with enamel, and their coefficients of expansion are very close, which causes the openwork item to retain excellent mechanical strength. These materials withstand firing cycles of up to 1000° C. for high-fire enamels, for example, and resist thermal shock for rapid firing cycles.

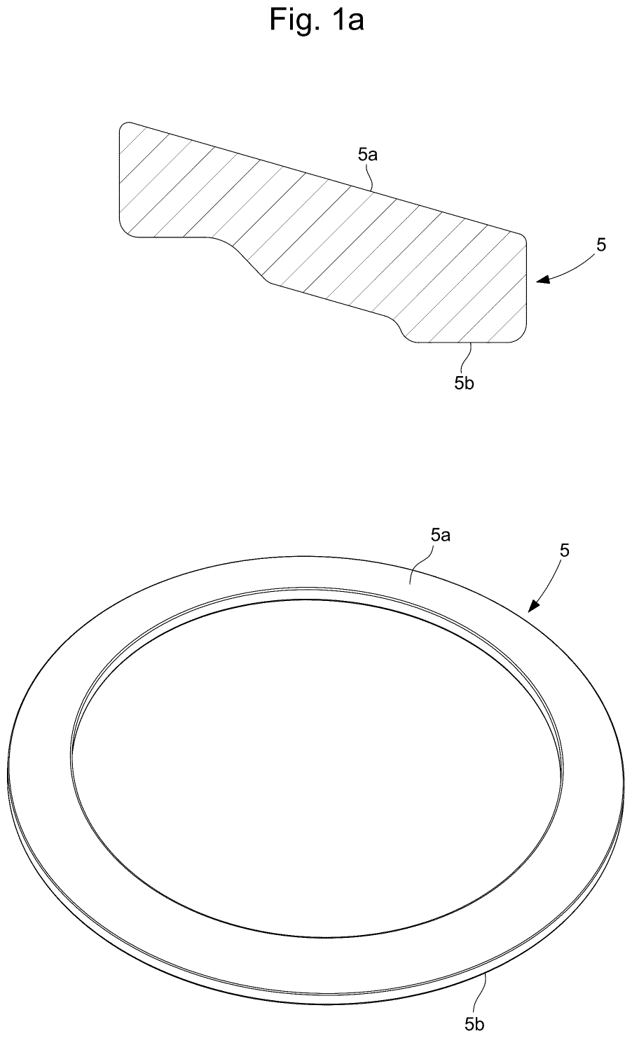

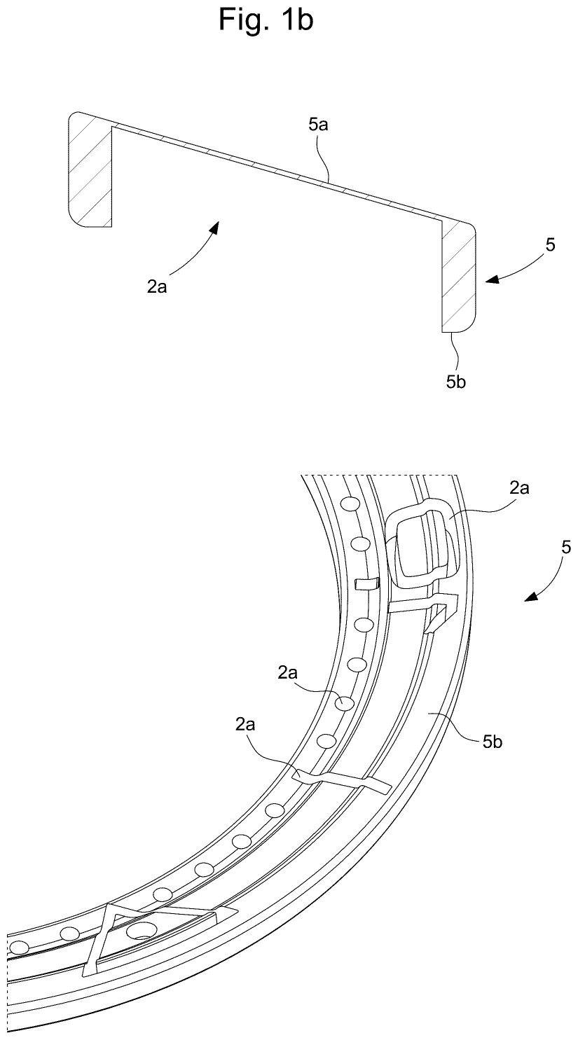

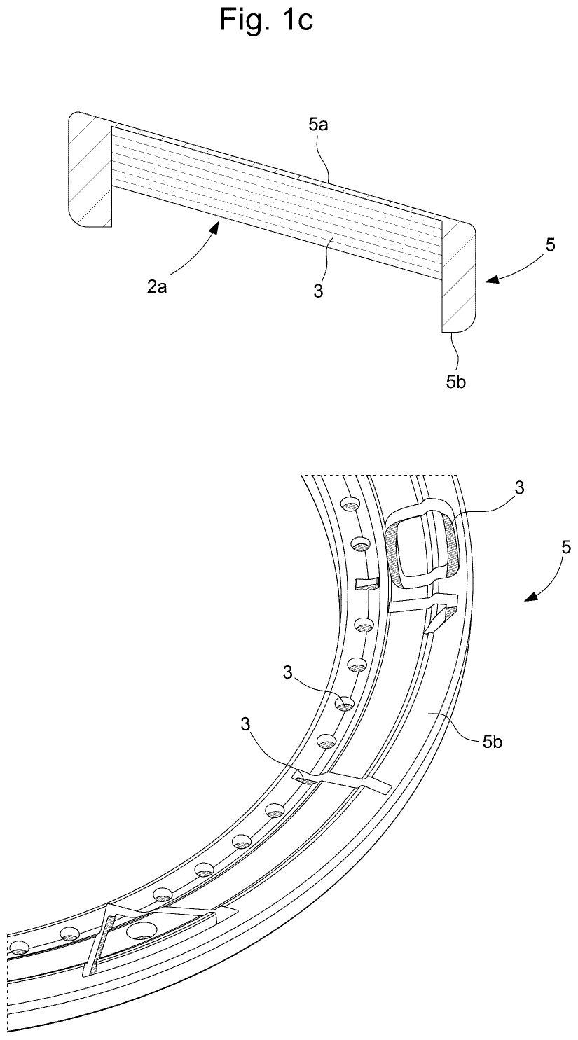

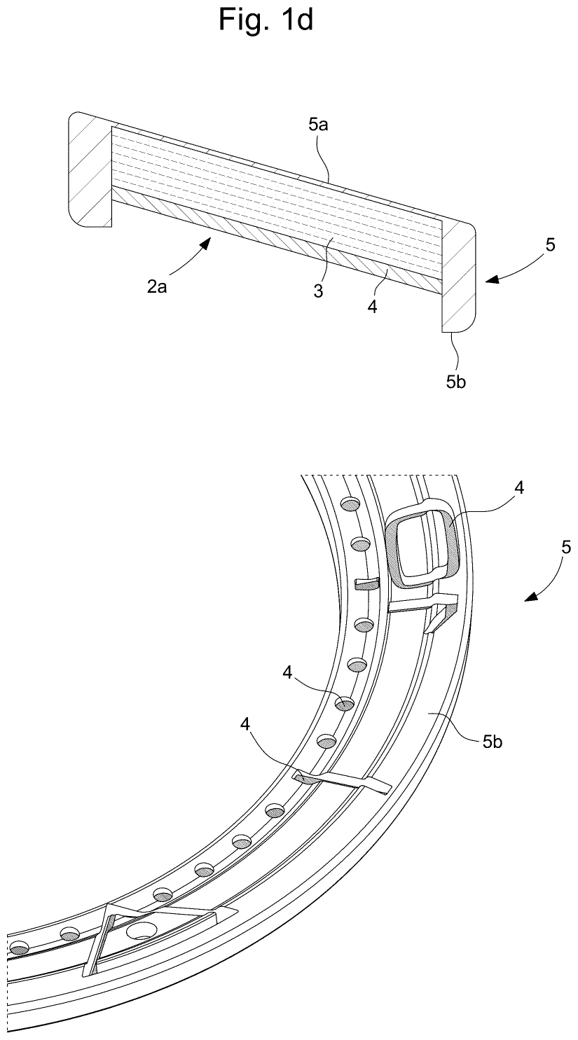

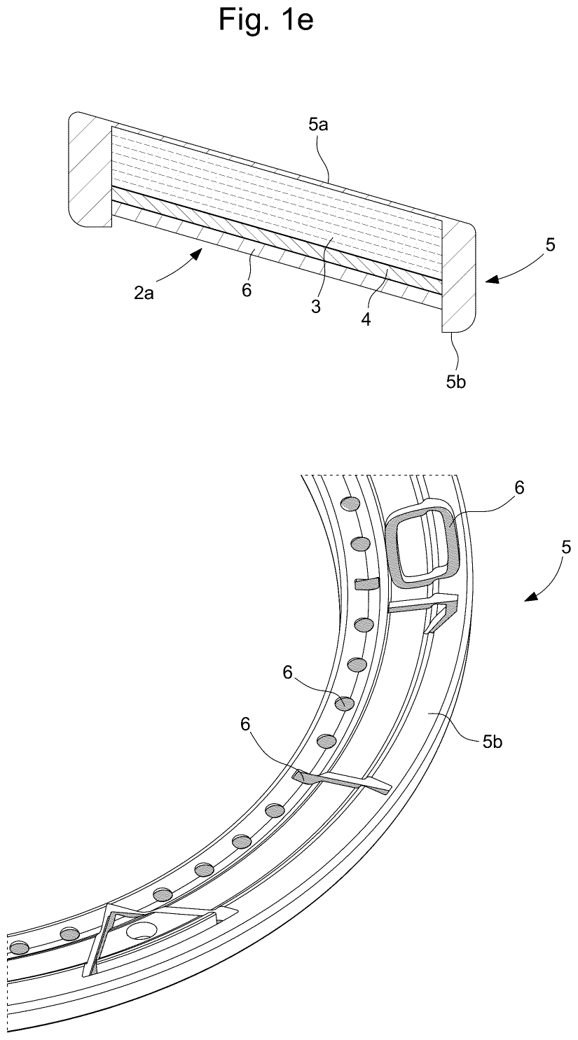

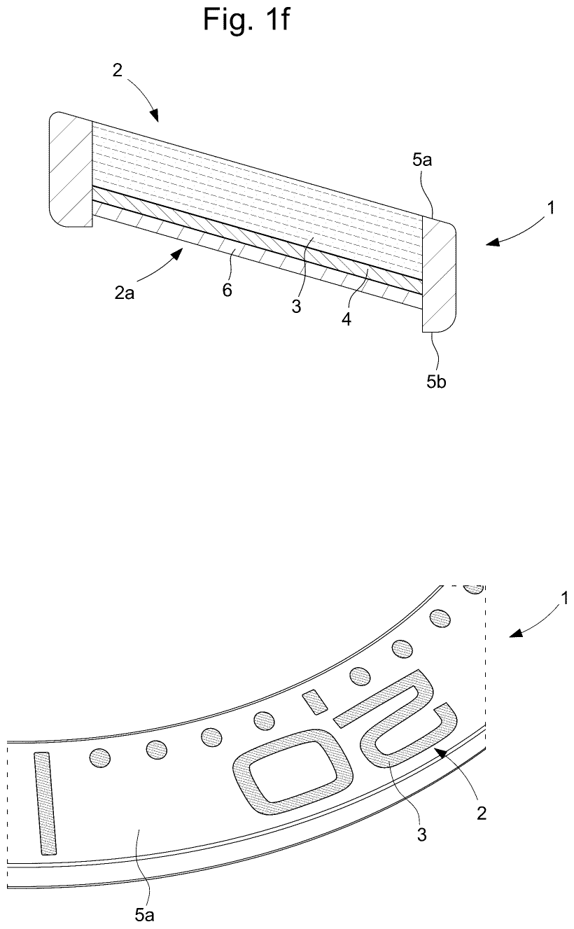

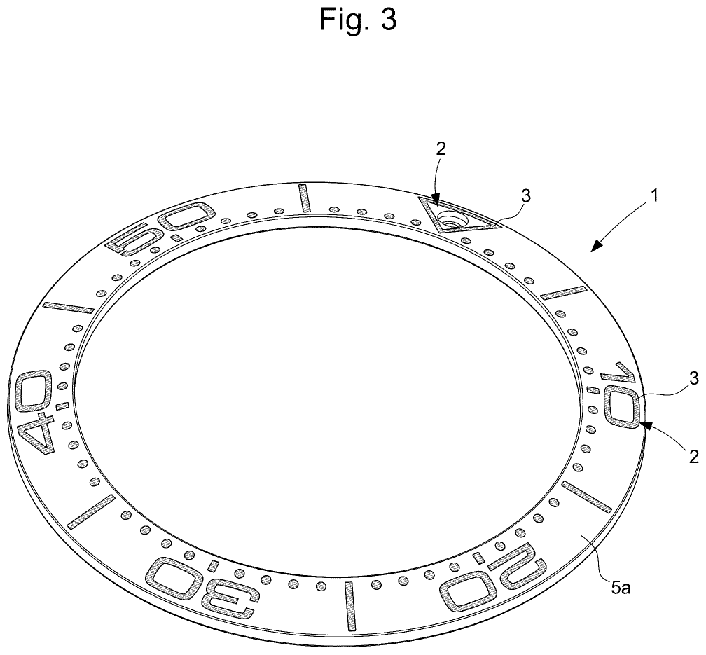

The method is illustrated in FIGS. 1a to 1f in 6 steps from a) to f) for a bezel. In a first step a), the item without any decoration, which will be referred to as a blank 5, is obtained. Then, in a second step b), a non-through decoration 2a is produced from the inner face 5b of the blank 5. The non-through decoration can, for example, be produced by laser ablation. Optionally, this step b) can be omitted if a blank provided with the non-through decoration 2a is directly obtained in step a), this blank being produced by injection moulding for example. In a third step c), the enamel 3 is deposited within the decoration 2a, again from the inside of the blank 5. Although not illustrated in FIG. 1c, during this step, the inner face 5b is preferably placed in the upper position to allow the enamel to be deposited. Ideally, the deposit is carried out by liquid spraying with a view to industrial production. Alternatively, it can be deposited quickly by hand using a brush or by sprinkling a powder. The blank 5 is then fired to vitrify the deposited enamel. Preferably, a plurality of layers of enamel are deposited with, after each deposition step, a firing cycle to ensure that the enamel is bubble-free. Enamel layers of different colours can be deposited and/or the colour of the enamel deposited for each layer can be varied. Typically, the total thickness of the enamel layers is greater than or equal to 0.5 mm, preferably greater than or equal to 0.8 mm, with a maximum total thickness of 1.5 mm or more depending on production times. In a fourth step d), once the decoration has been at least partially filled with enamel and fired, a layer of luminescent material 4 is deposited on the enamel 3, i.e. again from the inside of the blank, again with the inner face preferably in the upper position. For example, the luminescent material can be Super-LumiNova®, which is a phosphorescent pigment charged in a lacquer or an adhesive. This material offers a wide range of emission colours, including blue, green, purple, white, yellow, orange and pink, etc. In a fifth step e), a protective layer 6, such as a lacquer, is deposited on the layer of luminescent material 4, again with the inner face preferably in the upper position. A sixth machining step f) is then carried out, preferably by grinding, on the upper face 5a of the blank 5 to reveal the enamel 3, thus obtaining the through-decoration 2 backlit from the inside by the luminescent material 4. A final polishing operation can then be carried out to make the ground surface perfectly shiny and guarantee good transparency of the enamel. The resulting bezel is shown in FIG. 3.

Optionally, the outer face can be subjected to finishing treatments such as satin-finishing or laser texturing as described below. The enamel can also be textured on the inner face or within the enamel.

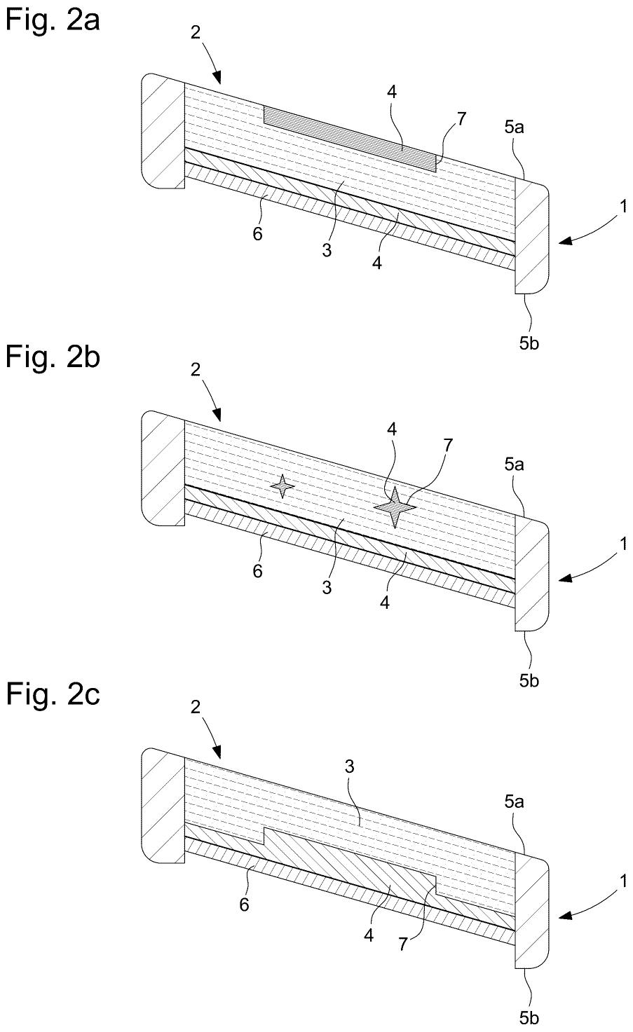

The optional texturing steps are illustrated in FIGS. 2a to 2c. These steps involve texturing the enamel 3, for example by laser engraving, to produce a structure 7. This structure can be maintained as such to give a particular aesthetic effect or can then be filled with material, for example luminescent material 4. In FIG. 2a, the enamel 3 is textured after the machining step on the visible face and luminescent material 4 is added to the structure 7. In FIG. 2b, the structure 7 is produced within the enamel 3. In FIG. 2c, the structure 7 is produced on the last layer of enamel 3 deposited under the blank before the layer of luminescent material 4 is deposited.

The item 1 obtained has the following features. It is provided with at least one through-decoration 2 filled with a stack of layers which are, from the outer face inwards: an enamel layer 3 resulting from the deposition and firing of one or more enamel layers, a layer of luminescent material 4 and a protective layer 6. The number of enamel layers deposited is typically between 2 and 15, preferably between 3 and 10, and the total thickness of the enamel obtained is typically greater than or equal to 0.5 mm, preferably greater than or equal to 0.8 mm with a maximum value that can reach 1.5 mm, or even more for longer production times.

Optionally, with reference to the additional steps in FIGS. 2a to 2c, the item 1 comprises, on its surface or in the enamel layer 3, one or more structures 7 which can be filled with a material, and more specifically with a luminescent material 4. These structures can be arranged at the visible surface, facing the inner surface opposite the visible surface, or between the two.

1. A method for manufacturing an item (1) comprising a through-decoration (2) filled with at least one enamel (3) and a luminescent material (4) to form a backlit plique-à-jour enamel, the method comprising the steps of:
obtaining a blank (5) defined with an outer face (5a), which is the face intended to face an observer, and with an inner face (5b), which is an opposite face to the outer face (5a);
removing part of the blank (5) from the inner face (5b) to produce a decoration (2a) that does not pass through to the outer face (5a) or, alternatively, in the previous step, obtaining said blank (5) directly with the non-through decoration (2a);
depositing, from the inner face (5b), one or more layers of enamel (3) within the non-through decoration (2a) and firing the enamel (3) after each layer has been deposited;
depositing, from the inner face (5b), a layer of luminescent material (4) on the enamel (3);
depositing, from the inner face (5b), a protective layer (6) on the layer of luminescent material (4); and
machining, preferably by grinding, the outer face (5a) to reveal the enamel (3) and thus produce the item (1) with the through-decoration (2).

2. The method according to claim 1, comprising, after the machining step, a step of polishing the outer face (5a) to add brightness to the through-decoration (2).

3. The method according to claim 1, wherein said blank (5) is made of a material with a melting point greater than or equal to 650° C.

4. The method according to claim 1, wherein the deposition of one or more layers of enamel (3) is carried out by liquid spraying, using a brush or by sprinkling a powder.

5. The method according to claim 1, wherein the number of layers of enamel (3) deposited is between 2 and 15, preferably between 3 and 10.

6. The method according to claim 1, wherein during the step of depositing one or more layers of enamel (3), layers of enamel (3) of different colours are deposited and/or the colour within the same layer is modulated.

7. The method according to claim 1, comprising a step of texturing the enamel (3) to form a structure (7) on the surface of the enamel (3) at the outer face (5a), within the enamel (3) during the deposition of the one or more layers of enamel (3), and/or on the surface of the enamel (3) at the layer of luminescent material (4).

8. The method according to claim 7, comprising a step of filling the structure (7) with the luminescent material (4).

9. An Item (1) comprising an outer face (5a) intended to face an observer and an inner face (5b) opposite to the outer face (5a), said item (1) comprising a through-decoration (2) made of backlit plique-à-jour enamel.

10. The item (1) according to claim 9, wherein the through-decoration (2) comprises, from the outer face (5a), a layer of enamel (3), a layer of luminescent material (4) and a protective layer (6).

11. The item (1) according to claim 9, wherein the layer of enamel (3) has a thickness greater than or equal to 0.5 mm, preferably greater than or equal to 0.8 mm.

12. The item (1) according to claim 9, said item (1) being an external timepiece component or component of the movement.

13. The item (1) according to claim 9, said item (1) being an external timepiece component.

14. The item (1) according to claim 9, said item (1) being made of a ceramic, a sapphire or a cermet.

15. The item (1) according to claim 14, said item (1) being made of zirconium oxide.
